(19) United States
(12) Patent Application Publication
(10) Pub. No.: US 2025/0255319 A1
(43) Pub. Date: Aug. 14, 2025

(54) METHOD FOR PRODUCING SMOKING MATERIAL AND SMOKING MATERIAL

(71) Applicant: HONDA MOTOR CO., LTD., Tokyo (JP)

(72) Inventor: Kentaro Tsuji, Tokyo (JP)

(73) Assignee: HONDA MOTOR CO., LTD., Tokyo (JP)

(21) Appl. No.: 19/039,909

(22) Filed: Jan. 29, 2025

(30) Foreign Application Priority Data
Feb. 9, 2024 (JP) 2024-018821
Jun. 18, 2024 (JP) 2024-098130

(51) Int. Cl. A23B 4/048; A23L 27/00

(52) U.S. Cl. CPC A23B 4/048; A23L 27/70

(57) ABSTRACT

A method for producing a smoking material includes: molding lees generated in a production process of a fermented food product into particles having an average particle size of 0.5 to 1.5 mm; placing the molded particles on a drying unit to have a thickness of 20 mm or less; and drying the particles placed on the drying unit to have a mass of 86% by mass or less of the mass before drying.

### CROSS-REFERENCE TO RELATED APPLICATION(S)

This application claims priority to and the benefit of Japanese Patent Application No. 2024-018821 filed on Feb. 9, 2024 and Japanese Patent Application No. 2024-098130 filed on Jun. 18, 2024, the entire disclosure of which are incorporated herein by reference.

### BACKGROUND OF THE INVENTION

### Field of the Invention

The present invention relates to a method for producing a smoking material and a smoking material. Description of the Related Art

Most of residues (lees) generated in the production process of a fermented food product have been disposed of as waste through incineration or the like. However, in order to reduce CO₂ from the viewpoint of climate-related disasters, it has been attempted to effectively use lees without incineration or the like. For example, soy sauce lees generated in the production process of soy sauce, which is a fermented food product, is used as feed for livestock and fertilizer for agricultural products. However, under the present circumstances where high nutritional value and inexpensive imported raw materials can be easily obtained, the value of soy sauce lees as a feed or a fertilizer is low, and the profitability may not be satisfactory.

Therefore, effective use of lees generated in the production process of a fermented food product was studied. Japanese Patent No. 6802616 discloses that lees generated in a production process of a fermented food product is used as a smoking material for smoking.

In order to use the lees as a smoking material, it is necessary to adjust the moisture content in the smoking material. However, in Japanese Patent No. 6802616, since the lees are used as an aqueous solution, and the extract and flavor thereof are transferred to wood to form a smoking material, the time for drying the wood is increased, and as a result, the production cost may be increased. Furthermore, when the moisture content of wood is large, corrosion, mold, and rotting odors of wood are likely to be generated, and treatment for suppressing the corrosion, mold, and rotting odors may be required.

### SUMMARY OF THE INVENTION

One embodiment of the present invention provides a method for easily producing a smoking material from lees generated in a production process of a fermented food product. In addition, one embodiment contributes to an environmental problem and a food loss problem.

According to one embodiment of the present invention, a method for producing a smoking material includes: molding lees generated in a production process of a fermented food product into particles having an average particle size of 0.5 to 1.5 mm; placing the molded particles on a drying unit to have a thickness of 20 mm or less; and drying the particles placed on the drying unit to have a mass of 86% by mass or less of the mass before drying.

According to one embodiment of the present invention, a smoking material is composed of components from the lees of fermented food product, wherein a moisture content is less than 25% by mass.

### DESCRIPTION OF THE EMBODIMENTS

Hereinafter, embodiments will be described in detail with reference to the attached drawings. Note that the following embodiments are not intended to limit the scope of the claimed invention, and limitation is not made an invention that requires all combinations of features described in the embodiments. Two or more of the multiple features described in the embodiments may be combined as appropriate. Furthermore, the same reference numerals are given to the same or similar configurations, and redundant description thereof is omitted.

Method for Producing Smoking Material according to Present Embodiment

According to the present embodiment, a method for producing a smoking material includes: molding lees generated in a production process of a fermented food product into particles having an average particle size of 0.5 to 1.5 mm; placing the molded particles on a drying unit to have a thickness of 20 mm or less; and drying the particles placed on the drying unit to have a mass of 86% by mass or less of the mass before drying. Thereby, the smoking material can be easily produced from the lees generated in the production process of a fermented food product.

Step of Molding Lees into Particles

In the method for producing a smoking material according to the present embodiment, first, lees generated in the production process of a fermented food product are molded into particles having an average particle size of 0.5 to 1.5 mm. The lees generated in the production process of a fermented food product is not particularly limited, and examples thereof include soy sauce lees, beer saccharified lees, beer yeast lees, whisky fermented lees, sake lees, and vinegar fermented lees. In addition, as the lees generated in the production process of these fermented food products, those provided by the producers of the fermented food products can be adopted. In one embodiment, lees generated in the production process of a fermented food product can be used as soy sauce lees. By using the soy sauce lees, it is possible to obtain a smoking material that produces smoked food products with a rich soy sauce aroma. Hereinafter, the method for producing a smoking material according to the present embodiment will be described using soy sauce lees as lees generated in the production process of a fermented food product.

The soy sauce lees are the residue after pressing the soy sauce flavor, and is not particularly limited, and soy sauce lees generated by various methods such as a main brewing method, a mixed brewing method (new brewing method), and a mixing method (amino acid addition method) can be used. The type of soybean as a raw material is also not particularly limited, and examples thereof include round soybean (unprocessed soybean), defatted soybean, and defatted soybean.

The soy sauce lees are molded into particles having an average particle size of 0.5 to 1.5 mm. The molding means is not particularly limited, but molding can be performed using a mincer, a juicer, or the like. The mincer and juicer are provided with a plate (filter) capable of adjusting the average particle size, and can mold the soy sauce lees into particles having an average particle size of 0.5 to 1.5 mm. Furthermore, although soy sauce lees have a relatively high viscosity, mincer and juicer can control the average particle size by selecting a filter while applying pressure and crushing even when the object to be molded has a relatively high viscosity. Therefore, in the molding with the mincer and juicer, clogging of the soy sauce lees and adhesion of the soy sauce lees to the inside of the molding device are suppressed.

The average particle size of the molded particles can be 0.3 mm or more in one embodiment, 0.5 mm or more in another embodiment, and 0.8 mm or more in another embodiment. As a result, the aroma of the lees remains sufficiently in the smoking material even after the drying step, and a good smoking material can be obtained. In addition, the average particle size of the molded particles can also be 2.0 mm or less in one embodiment, 1.5 mm or less in another embodiment, and 1.0 mm or less in another embodiment. As a result, in the drying step, it is possible to easily obtain a smoking material having an appropriate moisture content, and it is possible to obtain a smoking material having combustion stability and capable of releasing an appropriate smoking amount. The average particle size of the molded particles is obtained by a sieving method, and sieves are superposed in order from one having a small opening, samples remaining on each sieve are weighed, and the particle size at a cumulative 50% is taken as the average particle size.

### Step of Placing Molded Particles on Drying Unit

Next, the molded particles are placed on the drying unit to have a predetermined thickness, in other words, a predetermined height from the drying unit. The upper limit of the placement thickness of the molded particles can be 30 mm or less in one embodiment, 20 mm or less in another embodiment, and 15 mm or less in another embodiment. As a result, it is possible to easily obtain a smoking material having an appropriate moisture content, and it is possible to obtain a smoking material having combustion stability and capable of releasing an appropriate smoking amount. In addition, the lower limit of the placement thickness of the molded particles is not particularly limited, but can be 5 mm or more in one embodiment, 10 mm or more in another embodiment, and 15 mm or more in another embodiment. Accordingly, the space required for drying is reduced.

The arrangement of the molded particles is not particularly limited. For example, the molded particles may be arranged in contact with each other, in a non-contact manner, or in an overlapping manner. The molded particles as a whole can be placed on the drying unit in a plate shape having a predetermined thickness. The drying unit on which the molded particles are placed is not particularly limited as long as the molded particles can be placed, and may be a flat bottom container such as a plate member, a sheet member, or a tray.

### Step of Drying Particles Placed on Drying Unit

Next, the particles placed on the drying unit are dried. The drying conditions such as the drying method, the drying temperature, and the time are not particularly limited as long as the drying of the particles placed in the drying unit is performed such that the mass of the particles after drying is a predetermined value with respect to the mass before drying. For example, the particles may be dried by natural drying at, for example, 15 to 30° C. (near normal temperature) by placing the drying unit on which the particles are placed in a ventilated dark place, by drying at, for example, 15 to 30° C. (near normal temperature) by placing the drying unit on which the particles are placed in a device in which the temperature and humidity are kept constant, or by drying at, for example, 80 to 100° C. by placing the drying unit on which the particles are placed in a drying machine. During the drying, the particles placed on the drying unit may be stirred every predetermined time. As a result, the particles are uniformly dried, and the drying rate of the particles is increased.

In addition, the upper limit value of the mass of the particles after drying can be dried to be 90% by mass or less of the mass of the particles before drying in one embodiment, and 86% by mass or less of the mass of the particles before drying in another embodiment. As a result, generation of mold and odor can be suppressed, and a smoking material having an appropriate moisture content can be obtained. The mass of the particles after drying can be obtained by placing a predetermined amount (for example, 100 g) of particles to be distinguished from other particles and measuring the mass of the distinguished particles every predetermined time. In one embodiment, the particles may be dried such that the particles have a predetermined mass by determining in advance the relationship of the mass change of the particle with respect to the drying time of the particles and adjusting the drying time.

The lower limit value of the mass of the particles after drying is not particularly limited, but the particles can be dried to be 80% by mass or more of the mass of the particles before drying in one embodiment, and 84% by mass or more of the mass of the particles before drying in another embodiment. As a result, the aroma of soy sauce remains in the smoking material, and a good smoking material can be obtained.

Furthermore, the method for producing a smoking material according to the present embodiment may include determining the pass or fail of the smoking material.

### Step of Determining Pass or Fail of Dried Particles

A test may be performed to determine the pass or fail of the dried particles. In the pass or fail determination, the dried particles are combusted, and the pass or fail of the dried particles before combustion is determined based on the color of the particles after combustion. For example, when the dried particles are combusted and the color is changed to black as in the use as the smoking material, the dried particles are determined as pass as the smoking material, and when the color is changed to a color other than black like dark brown, the dried particles are determined as fail as the smoking material. Accordingly, it is possible to obtain a smoking material with stable quality. In addition, at the time of the pass or fail determination test of the dried particles, performance as a smoking material may be evaluated by further confirming smoke and combustion continuity, and performance as a smoking material may be evaluated by smoking a food product and confirming flavor to the food product and taste of the food product.

Furthermore, the method for producing a smoking material according to the present embodiment may include the following steps.

Step of Forming Smoking Material into Molded Body

The smoking material may be a molded body having a block shape. The method for forming the molded body (molded smoking material) of the smoking material is not particularly limited, and in one embodiment, the molded smoking material may be molded to have a predetermined size and shape by introducing the smoking material into a mold made of resin or metal, and can also be formed using a molding machine. In addition, in the molding, a pressure may be applied to remove the gas (air) inside. In another embodiment, the molded body of the smoking material may be prepared by adding a binding component to the material, mixing the components, introducing the mixture into a mold made of a resin or a metal, and molding the mixture to have a predetermined size and shape, and may be formed using a molding machine. In addition, in the molding, a pressure may be applied to remove the gas (air) inside.

When the binding component is used, carbohydrate (sugar) can be used as the binding component, and examples thereof include dextrin, pullulan, starch, hydroxypropyl cellulose, hydroxypropyl methyl cellulose, methyl cellulose, carboxymethyl cellulose, and galactomannan. The content of the binding component is not particularly limited, and may be 10% by mass or less in one embodiment, 7% by mass or less in another embodiment, and 5% by mass or less in still another embodiment, and 0.1% by mass or more in one embodiment, 1% by mass or more in another embodiment, and 3% by mass or more in still another embodiment with respect to the molded smoking material. As a result, a smoking material that can be maintained as a molded body and can release an appropriate smoking amount is obtained.

Step of Forming Smoking Material into Sintered Body

The smoking material may be a sintered body having a block shape. A method for forming the sintered body (sintered smoking material) of the smoking material is not particularly limited, and the molded smoking material having no binding component or the molded smoking material having a binding component may be fired. The firing temperature is not particularly limited, and is selected, for example, from the range of 50 to 150° C. In the firing, the molded body may be fired while being placed in a molded body, or the molded body may be removed from the molded body and fired.

Smoking Material according to Present Embodiment

The smoking material according to the present embodiment, in the smoking material composed of components from the lees of fermented food product, a moisture content is less than 25% by mass. The smoking material is made of components from the lees of fermented food product and does not contain wood, and thus the corrosion, mold, or rotting odors which are generated depending on the moisture content of wood are not generated.

The lees of fermented food product can be as described above in <Method for Producing Smoking Material according to Present Embodiment> Hereinafter, the smoking material according to the present embodiment will be described using soy sauce lees as lees generated in the production process of a fermented food product. In addition, the components contained in the lees of fermented food product vary depending on the fermented food product, but for example, soy sauce lees contains dietary fiber, moisture, ash, protein, lipid, carbohydrate, salt, and the like. Ash is a residue obtained by ashing food products at a high temperature and removing organic substances and moisture, and examples thereof include minerals such as potassium, sodium, and iron. The smoking material may consist of a component from lees of fermented food product or may contain a component that generates smoke aroma.

The average particle size of the smoking material is not particularly limited, but may be 0.5 to 1.5 mm. The average particle size of the smoking material is substantially equal to the average particle size of the lees molded in the production process of the smoking material. Therefore, the average particle size of the smoking material can be 0.3 mm or more in one embodiment, 0.5 mm or more in another embodiment, and 0.8 mm or more in another embodiment, and can be 2.0 mm or less in one embodiment, 1.5 mm or less in another embodiment, and 1.0 mm or less in another embodiment. As a result, it is possible to obtain a smoking material having an appropriate moisture content, and it is possible to obtain a smoking material having combustion stability and capable of releasing an appropriate smoking amount. The average particle size of the smoking material is obtained by a sieving method, and sieves are superposed in order from one having a small opening, samples remaining on each sieve are weighed, and the average particle size at a cumulative 50% is taken as the average particle size.

The upper limit of the moisture content of the smoking material may be less than 25% by mass in one embodiment, and may be 20% by mass or less in another embodiment. As a result, generation of corrosion, mold, rotting odors can be suppressed, and a smoking material having an appropriate moisture content can be obtained. The moisture content of the smoking material can be determined from the mass of the smoking material before and after drying after the smoking material is dried at approximately 110° C. for 2 hours.

The lower limit of the moisture content of the smoking material is not particularly limited, but may be 10% by mass or more of the mass of the particles before drying in one embodiment, and 15% by mass or more in another embodiment. As a result, the aroma of soy sauce remains in the smoking material, and a good smoking material can be obtained.

### Molded Smoking Material

The smoking material may be a molded body having a block shape. A molded body of smoking material (molded smoking material) is a set of a plurality of smoking materials, and has a regular shape. The shape of the molded smoking material is not particularly limited, and examples thereof include rectangular prism, cylindrical rod, cube, sphere, pyramids such as triangular pyramids and square pyramids, and disk shapes. In one embodiment, the molded smoking material is in a rectangular prism (block-shaped) shape. The dimensions of the block-shaped molded smoking material are not particularly limited, and the cross section perpendicular to the longitudinal direction may be 10 to 50 mm×10 to 50 mm, and the length in the longitudinal direction may be 100 to 300 mm. As an example, the dimensions of the block-shaped molded smoking material can be 40 mm×40 mm×180 mm. The cross section is not limited to a square, and may be a rectangle.

The molded smoking material may have a binding component. Carbohydrate (sugar) can be used as the binding component, and examples thereof include dextrin, pullulan, starch, hydroxypropyl cellulose, hydroxypropyl methyl cellulose, methyl cellulose, carboxymethyl cellulose, and galactomannan. The content of the binder is not particularly limited, and may be 10% by mass or less in one embodiment, 7% by mass or less in another embodiment, and 5% by mass or less in still another embodiment, and 0.1% by mass or more in one embodiment, 1% by mass or more in another embodiment, and 3% by mass or more in still another embodiment with respect to the molded smoking material. As a result, a smoking material that can be maintained as a molded body and can release an appropriate smoking amount is obtained.

The moisture content of the molded smoking material can be less than 25% by mass in one embodiment and 20% by mass or less in another embodiment, and can be 10% by mass or more of the mass of the particles before drying in one embodiment and 15% by mass or more in another embodiment. As a result, generation of corrosion, mold, and rotting odors can be suppressed, a smoking material having an appropriate moisture content can be obtained, the aroma of soy sauce remains in the smoking material, and a good smoking material can be obtained. The moisture content of the molded smoking material can be determined from the mass of the molded smoking material before and after drying after the smoking material is dried at approximately 110° C. for 2 hours.

### Sintered Smoking Material

The smoking material may be a sintered body. The sintered body (sintered smoking material) of the smoking material is obtained by sintering a plurality of smoking materials, and has a regular shape. The shape of the sintered smoking material is not particularly limited, and examples thereof include rectangular prism, cylindrical rod, cube, sphere, pyramids such as triangular pyramids and square pyramids, and disk shapes. In one embodiment, the sintered smoking material is in a rectangular prism (block-shaped) shape. The dimensions of the block-shaped sintered smoking material are not particularly limited, and the cross section perpendicular to the longitudinal direction may be 10 to 50 mm×10 to 50 mm, and the length in the longitudinal direction may be 100 to 300 mm. As an example, the dimensions of the block-shaped sintered smoking material can be 40 mm×40 mm×180 mm. The cross section is not limited to a square, and may be a rectangle.

The sintered smoking material may have a binding component. As the binding component, the same components as those contained in the molded smoking material can be included, and the content of the binding component can also be the same. As a result, a smoking material that can be maintained as a sintered body and can release an appropriate smoking amount is obtained.

The moisture content of the sintered smoking material can be less than 25% by mass in one embodiment and 20% by mass or less in another embodiment, and can be 10% by mass or more of the mass of the particles before drying in one embodiment and 15% by mass or more in another embodiment. As a result, generation of corrosion, mold, and rotting odors can be suppressed, a smoking material having an appropriate moisture content can be obtained, the aroma of soy sauce remains in the smoking material, and a good smoking material can be obtained. The moisture content of the sintered smoking material can be determined from the mass of the sintered smoking material before and after drying after the smoking material is dried at approximately 110° C. for 2 hours.

The molded smoking material and the sintered smoking material may have a groove or the like for cutting such that the amount used can be adjusted. The molded smoking material and the sintered smoking material may be partially provided with an ignition agent or the like. As a result, once the ignition agent is ignited, smoke can be continuously emitted for a certain period of time.

The smoking material in which the plurality of smoking materials are not bound or the like is easily used by hot smoking because the internal temperature of the smoker increases in a short period of time. On the other hand, the lump-shaped smoking material, the molded smoking material, and the sintered smoking material can continuously emit smoke for a long period of time, and thus can be easily used by warm smoking or cold smoking.

### Summary of Embodiments

The above embodiment discloses at least the following method for producing a smoking material and the smoking material.

1. A method for producing a smoking material according to the above embodiment includes:
molding lees generated in a production process of a fermented food product into particles having an average particle size of 0.5 to 1.5 mm;
placing the molded particles on a drying unit to have a thickness of 20 mm or less; and
drying the particles placed on the drying unit to have a mass of 86% by mass or less of the mass before drying.

According to this embodiment, the smoking material can be easily produced from the lees generated in the production process of a fermented food product, and the generation of corrosion, mold, and rotting odors can be suppressed, and the smoking material having an appropriate moisture content can be obtained.

2. In the above embodiment,
the particles placed on the drying unit are dried to have a mass of 84 to 86% by mass of the mass before drying.

According to this embodiment, generation of corrosion, mold, and rotting odors can be suppressed, and a good smoking material having an appropriate moisture content and retaining the aroma of soy sauce in the smoking material can be obtained.

3. In the above embodiment,
the lees are soy sauce lees.

According to this embodiment, a smoked food product having a savory aroma of soy sauce can be obtained.

4. In the above embodiment,
the molding is performed using a mincer.

According to this embodiment, clogging and adhesion of lees to the inside of the apparatus are suppressed even when the object to be molded has a relatively high viscosity.

5. The above embodiment,
further includes: combusting the dried particles and determining pass or fail of the dried particles before combustion based on a color of the particles after combustion.

According to this embodiment, it is possible to obtain a smoking material with stable quality.

6. In the above embodiment,
when the color of the particles after combustion is black, the dried particles before combustion are determined as pass.

According to this embodiment, it is possible to obtain a smoking material with stable quality.

7. In a smoking material according to the above embodiment,
the smoking material is composed of components from the lees of fermented food product
a moisture content is less than 25% by mass.

According to this embodiment, a smoking material is made of components from the lees of fermented food product and does not contain wood, and thus the corrosion, mold, or rotting odors which are generated depending on the moisture content of wood are suppressed, and it is possible to obtain a smoking material with an appropriate moisture content.

8. The above embodiment consists of a component from the lees of fermented food product.

According to this embodiment, since a smoking material is made of components from the lees of fermented food product and does not contain wood, the corrosion, mold, and rotting odors which are generated depending on the moisture content of wood are suppressed, and a smoking material having an appropriate moisture content can be obtained. 9. In the above embodiment,
the lees of fermented food product are soy sauce lees.

According to this embodiment, a smoked food product having a savory aroma of soy sauce can be obtained.

10. In the above embodiment,
the moisture content is 20% by mass or less.

According to this embodiment, corrosion, mold, and rotting odors are suppressed, and a smoking material having an appropriate moisture content can be obtained.

11. In the above embodiment,
particles have an average particle size of 0.5 to 1.5 mm.

According to this embodiment, corrosion, mold, and rotting odors are suppressed, and a smoking material having an appropriate moisture content can be obtained.

12. In the above embodiment,
particles have the moisture content of 20% by mass or less and the average particle size of 0.5 to 1.5 mm.

According to this embodiment, corrosion, mold, and rotting odors are suppressed, and a smoking material having an appropriate moisture content can be obtained.

13. In the above embodiment,
the smoking material is molded to have a block shape.

According to this embodiment, it is easy to use by warm smoking or cold smoking.

14. In the above embodiment,
the moisture content is 20% by mass or less.

According to this embodiment, corrosion, mold, and rotting odors are suppressed, and a smoking material having an appropriate moisture content can be obtained.

15. The above embodiment contains a binding component.

According to this embodiment, the smoking material can have a predetermined dimension and shape.

16. In the above embodiment,
the smoking material is sintered to have a block shape.

According to this embodiment, it is easy to use by warm smoking or cold smoking.

17. In the above embodiment,
the moisture content is 20% by mass or less.

According to this embodiment, corrosion, mold, and rotting odors are suppressed, and a smoking material having an appropriate moisture content can be obtained.

18. The above embodiment contains a binding component.

According to this embodiment, the smoking material can have a predetermined dimension and shape.

### EXAMPLES

Hereinafter, the present embodiment will be described with reference to examples. However, the present embodiment is not limited to the following examples without departing from the gist thereof.

### Example 1

20 kg of soy sauce lees was sequentially charged into a mincer provided with a plate having an opening of 1 mm, and the soy sauce lees was molded into particles having an average particle size of 0.5 to 1.5 mm. In addition, the mincer used had a plate having a plurality of openings of 1 mm, and accordingly, the molded soy sauce lees were molded to an average particle size of 1 mm. The molded particles were placed on a sheet member, which is a drying unit, to have a thickness of approximately 20 mm. To check the degree of dryness, 100 g of molded particles were placed to be distinguished from other molded particles. The drying unit on which the molded particles were placed was placed in a ventilated dark place, and the molded particles of the soy sauce lees were dried at near normal temperature (approximately 23° C.). The mass of the distinguished molded particles was measured approximately every 24 hours (one day) from the start of drying to determine the mass after drying, and the molded particles were stirred.

The molded particles were dried for approximately 96 hours (4 days). The dried molded particles had a mass of 85% by mass of the mass before drying. The average particle size of the molded particles was 1.0 mm, and the moisture content was 18% by mass. The moisture content of the dried molded particles was determined from the mass of the molded particles before and after drying by drying the dried molded particles at approximately 110° C. for 2 hours.

### Comparative Example 1

Dried molded particles were prepared in the same manner as in Example 1 except that the molded particles were dried for approximately 72 hours (3 days). The dried molded particles had a mass of 92% by mass of the mass before drying. The average particle size of the molded particles of Comparative Example 1 was 1.0 mm, and the moisture content was 25% by mass.

### Evaluation of Smoking Material

The dried molded particles of Example 1 and Comparative Example 1 were separately placed in a smoker containing a food product and combusted to check the color change of the molded particles after combustion, combustion continuity, aroma to the food product, and taste of the food product. In addition, the dried molded particles of Example 1 and Comparative Example 1 were placed in a sealed container, stored for approximately one month, and the state after storage was confirmed.

The color of the molded particles after combustion in Example 1 changed to black. The molded particles emitted smoke for approximately 4 hours and exhibited sufficient combustion continuity. In addition, the smoked food product had a savory aroma of soy sauce and had a soy sauce flavor. In addition, the dried molded particles of Example 1 stored for approximately one month had no change in color or the like, and the generation of mold was not confirmed. Thus, the dried molded particles of Example 1 proved to be a good smoking material.

The color of the molded particles after combustion in Comparative Example 1 changed to dark brown. The molded particles emitted smoke for approximately 4 hours and exhibited sufficient combustion continuity. However, the smoked food product had a weak aroma and flavor of soy sauce. In addition, the dried molded particles of Comparative Example 1 stored for approximately one month had no change in color, but the generation of mold was confirmed. From this, the dried molded particles of Comparative Example 1 could not be used as a smoking material.

The invention is not limited to the foregoing embodiments, and various variations/changes are possible within the spirit of the invention.

What is claimed is:

1. A method for producing a smoking material, the method comprising:
molding lees generated in a production process of a fermented food product into particles having an average particle size of 0.5 to 1.5 mm;
placing the molded particles on a drying unit to have a thickness of 20 mm or less; and
drying the particles placed on the drying unit to have a mass of 86% by mass or less of the mass before drying.

2. The method for producing a smoking material according to claim 1, wherein the particles placed on the drying unit are dried to have a mass of 84 to 86% by mass of the mass before drying.

3. The method for producing a smoking material according to claim 1, wherein the lees are soy sauce lees.

4. The method for producing a smoking material according to claim 1, wherein the molding is performed using a mincer.

5. The method for producing a smoking material according to claim 1, further comprising: combusting the dried particles and determining pass or fail of the dried particles before combustion based on a color of the particles after combustion.

6. The method for producing a smoking material according to claim 5, wherein when the color of the particles after combustion is black, the dried particles before combustion are determined as pass.

7. A smoking material composed of components from the lees of fermented food product, wherein a moisture content is less than 25% by mass.

8. The smoking material according to claim 7, consisting of a component from the lees of fermented food product.

9. The smoking material according to claim 7, wherein the lees of fermented food product are soy sauce lees.

10. The smoking material according to claim 7, wherein the moisture content is 20% by mass or less.

11. The smoking material according to claim 7, wherein particles have an average particle size of 0.5 to 1.5 mm.

12. The smoking material according to claim 7, wherein particles have the moisture content of 20% by mass or less and the average particle size of 0.5 to 1.5 mm.

13. A smoking material according to claim 7, wherein the smoking material is molded to have a block shape.

14. The smoking material according to claim 13, wherein the moisture content is 20% by mass or less.

15. The smoking material according to claim 13 containing a binding component.

16. A smoking material according to claim 7, wherein the smoking material is sintered to have a block shape.

17. The smoking material according to claim 16, wherein the moisture content is 20% by mass or less.

18. The smoking material according to claim 16, containing a binding component.
